(19) United States
(12) Patent Application Publication
(10) Pub. No.: US 2011/0213711 A1
(43) Pub. Date: Sep. 1, 2011

(54) METHOD, SYSTEM AND APPARATUS FOR PROVIDING TRANSACTION VERIFICATION

(75) Inventors: Eric R. Skinner, Ottawa (CA); Steve Robert Neville, Orleans (CA); Michael Andrew Moir, Carp (CA)

(73) Assignee: Entrust, Inc., Dallas, TX (US)

(21) Appl. No.: 12/715,199

(22) Filed: Mar. 1, 2010

(51) Int. Cl. G06F 21/00; H04W 4/24; H04W 12/04

(52) U.S. Cl. 705/71; 455/414.1; 455/410

(57) ABSTRACT

A system and method provides electronic transaction verification using multiple different units. A first unit initiates an electronic transaction in response to user authentication affirmation by, for example, a server (such as a web server). After the user has been authenticated, another unit, such as a mobile device, receives a transaction confirmation request for the electronic transaction that is ongoing via the first unit. In addition, the second unit also receives from, for example, the server, transaction information based on the electronic transaction. The second device through a user interface and without requiring a user to enter transaction information, provides the received transaction information from the server for evaluation by a user of the second unit. The second unit requests from the user, in response to the transaction confirmation request, confirmation of the transaction. The second unit generates a transaction confirmation code based on the received transaction information if the transaction is confirmed by the user of the second unit and sends it to the server for verification by the server.

### BACKGROUND OF THE DISCLOSURE

The disclosure relates generally to methods and systems that employ authentication techniques for electronic transactions such as product purchases, bill payments, money transfers, purchase or sales of securities, other banking transactions or any other transactions that require secure verifications.

Multi-device user authentication systems are known that allow, for example, a first unit to authenticate a user with a web server, to provide a first level of authentication for a user of the first unit that is initiating an electronic transaction. The first device may have the user enter a password and PIN. A second level of authentication may be provided using a second device such as a user's cell phone wherein the web server sends a second level authentication code (such as a one time passcode) to the mobile device using a wireless SMS back channel. The user then reads the authentication code from the mobile device and enters it into the first unit as a second level of authentication to authenticate the user to the web server. The authentication code from the mobile device may also be automatically sent wirelessly to the first unit that initiated the transaction. However, once the user has been authenticated and a transaction is carried out after user authentication, malware can interfere with a unit's web browser to change transaction information such as dollar amounts for a wire transfer and the like causing the computer to send account information or wire money to a rogue site or account. Also the aforementioned out of band passcode technique involves sending a passcode that is not tied to details of the transaction.

Other systems require, for example, a user of one device to read transaction information and type the transaction information into a cell phone to complete a transaction wherein the transaction information may be, for example, dollar amounts in a wire transfer along with account information. Such techniques are cumbersome for the user since a large string of numbers typically needs to be typed in and keypads on handheld mobile devices are small. This can result in a user mistyping transaction information resulting in an error in the transaction. The user may have to enter a “to” and a “from” account information on the second device along with the other details of the account which can be entered incorrectly and cause difficulty in carrying out transactions.

Another system is known that utilizes a transaction verification technique employing multiple units. For example, a first unit carries out the transaction with a server and a second specially designed device that is dedicated for transaction verification is connected via, for example, a USB port (wired or wirelessly) to the first unit. The first unit passes transaction information to the second device which may display the transaction information to a user. The second device may then be used to confirm whether the transaction should be carried out. However, since such systems depend on the first device (which may contain malware and thus is not trustworthy) to transmit the transaction information to the second unit, the second unit may display untrustworthy transaction information, may require special software to be installed on the first unit besides a web browser, and/or may require a physical connection cable which is inconvenient for the user.

Accordingly, an improved electronic transaction system, method and devices are desired.

### BRIEF DESCRIPTION OF THE DRAWINGS

The embodiments will be more readily understood in view of the following description when accompanied by the below figures and wherein like reference numerals represent like elements, wherein:

FIG. 1 is a block diagram illustrating one example of a system for providing electronic transaction verification in accordance with one example set forth in the disclosure;

FIG. 2 is a flowchart illustrating one example of a method for providing electronic transaction verification based on the system of FIG. 1, for example;

FIG. 3 is a flowchart illustrating one example of a method for providing electronic transaction verification from the perspective of a mobile device in accordance with one example of the disclosure; and

FIGS. 4 and 5 illustrate examples of graphic user interfaces of a transaction verification application in accordance with one example set forth in the disclosure.

### DETAILED DESCRIPTION OF THE PREFERRED EMBODIMENTS

Briefly, a system and method provides electronic transaction verification using multiple different units. A first unit initiates an electronic transaction in response to user authentication affirmation by, for example, a server (such as a web server). Another unit, such as a mobile device, receives a transaction confirmation request for the electronic transaction that is ongoing via the first unit. In addition, the second unit also receives from, for example, the server, transaction information based on the electronic transaction. The second device through a user interface and without requiring a user to enter transaction information, provides the received transaction information from the server for evaluation by a user of the second unit. The second unit requests from the user, in response to the transaction confirmation request, confirmation of the transaction. For example, if the second unit is a mobile device, the mobile device may display details of the transaction that is being carried out by the other unit such as dollar amounts of the transaction, names of the parties in the transaction, etc. which is sent by the server to the mobile device via a back channel. If the user of the mobile device agrees with the terms of the transaction as provided by the mobile device from the server, the user confirms the transaction by, for example, activating a selectable graphic icon, audibly confirming the transaction or through some other user interface mechanism. The mobile device generates a transaction confirmation code based on the received transaction information if the transaction is confirmed by the user of the mobile device.

Transaction information is based on the transaction and may be data such as account information, balances, or any other suitable information that is required in an electronic transaction, such as but not limited to, a web based transaction, that was originated by the first unit after some form of user authentication process has been confirmed to allow the user to communicate with the server handling the transaction. As also used herein a server may be one or more servers including web servers and any other network elements or any other suitable elements to facilitate communication between the first unit and the second unit as described herein. It will be recognized that the operations of the various blocks described herein may be shared or carried out by other portions as desired.

By way of example, a transaction confirmation code may be, for example, the electronically signed transaction information that was generated by digitally signing the transaction information that was received from the server. In one example, the transaction information is digitally signed by the second unit using an OATH signing algorithm to produce the transaction verification code, however any suitable cryptographic signing technique may be used. The transaction confirmation code is sent back to the web server for verification, either by comparing against an expected transaction confirmation code that was generated by the server, or by performing a public key signature verification operation. The transaction code can be sent back to the server by the second unit or displayed on the second unit and entered into the first unit by the user and sent back to the server by the first unit. If the expected confirmation code is verified successfully at the server, the server carries out the transaction on behalf of the user of the first unit.

In another example, a mobile device provides the transaction information and transaction confirmation request through a mobile transaction verification application which provides suitable graphic user interfaces. In addition, the application also maintains a transaction history of all transaction confirmation requests that the mobile device has received from any server, and whether they were confirmed or rejected.

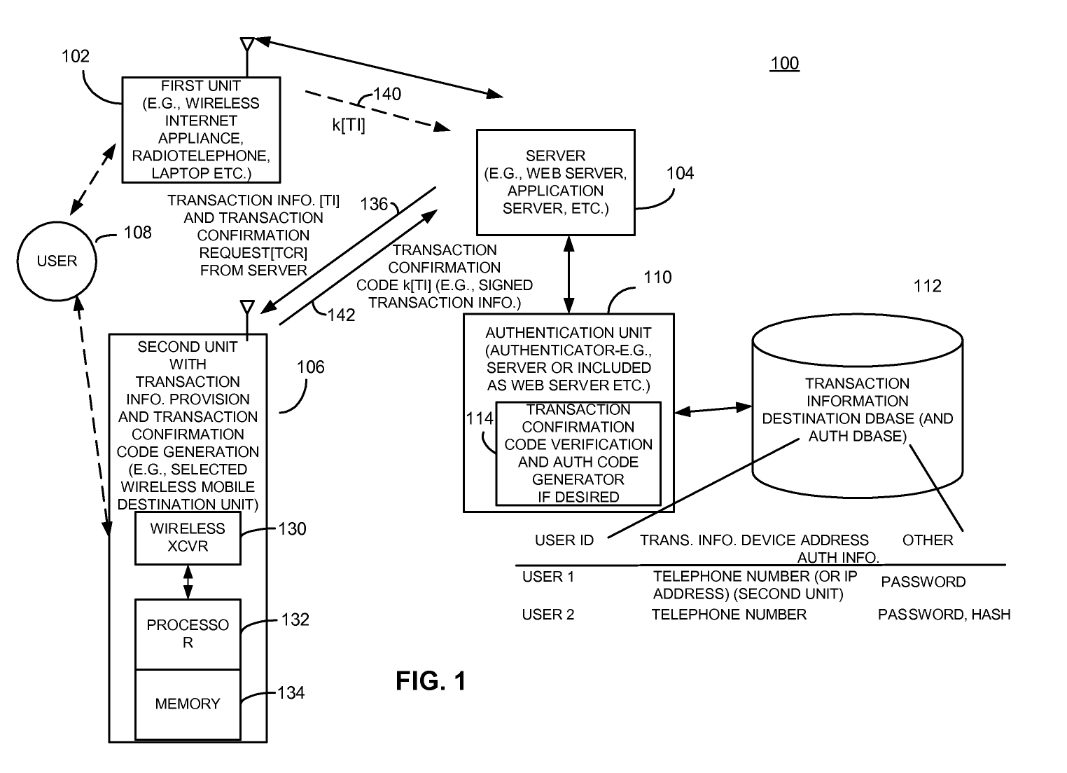

FIG. 1 illustrates one example of an electronic transaction system 100 that includes a first unit 102, a server 104 in communication with the first unit 102 during an electronic transaction, a second unit 106 that is different from the first unit 102 but may be in communication with the server 104 via any suitable network or networks via a different channel and as used herein can be in communication via a back channel such as a mobile carrier's data network communication channel or any other suitable channel. The system 100 may be for example, any suitable communication system but is described for purposes of illustration and not limitation, as a web based system wherein the server 104 may be a web server operatively coupled to the internet and operatively coupled to a wired and/or wireless networks.

The first unit 102 may be for example, a wireless internet appliance, radio telephone, PDA, laptop computer or any other suitable device that is used to carry out an electronic transaction and in this example includes a web browser to facilitate a web based financial transaction or any other suitable transaction with the server 104. The server 104 may be for example, a web server (a server coupled to the internet) for a banking institution, other financial institution, or any other suitable organization that wishes to provide a service via an electronic transaction. The first unit 102 allows a user 108 to provide identification information such as a password and/or personal identification number to the server 104 to facilitate user authentication in any suitable manner including first and second level authentication techniques as known in the art.

The server 104 may include for example, one or more processors and associated memory as known in the art to provide web server functionality. The server 104 may be one or more servers grouped together and may include an authentication unit 110 to provide cryptographic authentication schemes with the first unit and second unit 106. In this example, the server 104 utilizes an authentication unit that includes a transaction confirmation code verification provider 114 that verifies digital signatures, provides user authentication services and any other suitable security services.

The second unit 106 may be any suitable unit and in this example is referred to as a wireless mobile device. However, any suitable device may be employed. The second unit 106 includes in this example a wireless transceiver 130, one or more digital processors 132 and corresponding memory 134. The memory 134 as known in the art stores instructions, that when executed by the processor 132, causes the processor to carry out operations described herein. The processor 132 may be one or more suitably programmable digital processors as known in the art.

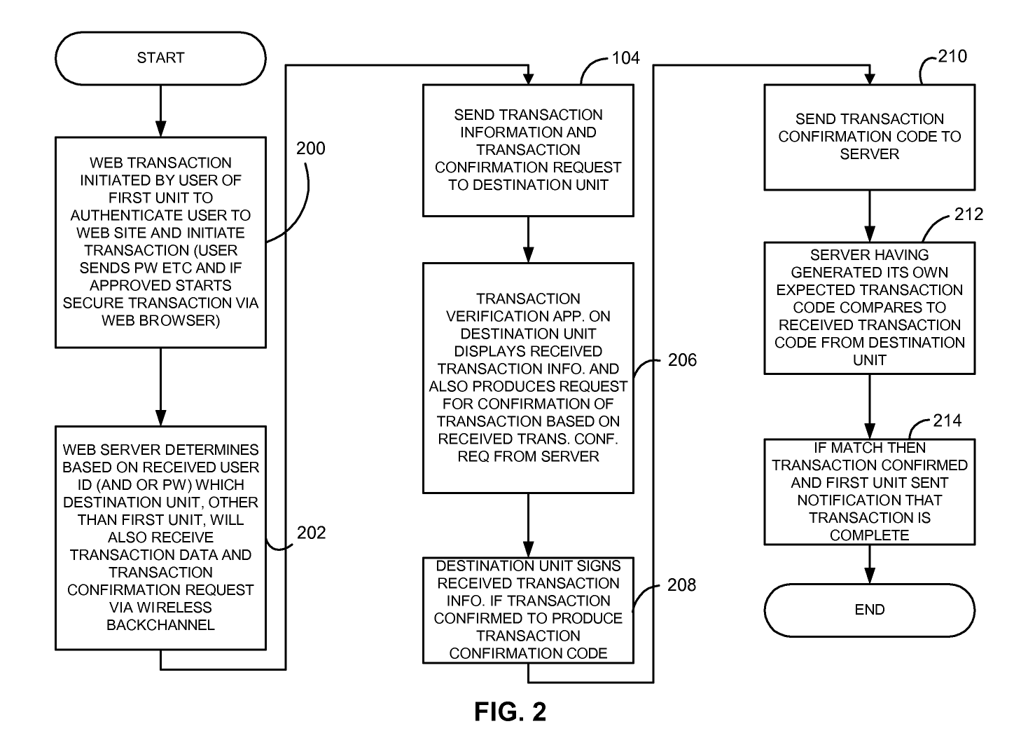

Referring also to FIG. 2, the operation of the system of FIG. 1 will be explained. During a registration process, in addition to providing information regarding the first unit for the user authentication process, a user provides mobile device identification information corresponding to the second unit to be associated with the user's digital identity. This information may be stored in the transaction information destination database and authentication database 112. Differing information may be used for differing purposes. For example, a password and PIN may be used for user authentication purposes to initiate a transaction. Once the transaction is initiated, however, that is described herein, transaction verification operations are performed. In this example, for purposes of transaction verification, a seed is generated by the authentication unit 110 and provided to the second unit 106 as part of the user's registration process. This may be performed, for example, in accordance with the OATH algorithm or any other suitable algorithm as desired. Alternatively the second unit can generate the key and provide it to the server. However, seeding is not dependent on the first unit for any calculation thereof.

The second unit 106 includes a transaction verification application executing on the processor 132 that when executed provides an interface as part of a registration process to allow the user to provide mobile device identification information and to obtain the seed or the key from the server to be used to generate a transaction verification code as later described. Also as part of the registration process, the verification application may also be setup to require the user of the second unit to enter a password or other authentication requirements before the transaction verification application can be opened to verify a transaction as described herein. In one example, the transaction information destination database 112 includes for example, the phone number of the second unit which serves as mobile device identification information (e.g., a destination unit identifier) for transaction information that will be used to verify a transaction being carried out by the first unit 102 and the server 104. For example the transaction information may be sent using the data network of a wireless service provider. Multiple users may be handled by the server and multiple users may have one or more secondary units that can be used to verify transactions. However, in this example for ease of illustration, a single second unit will be registered by the user of the first unit. In addition, the user authentication requirements may also be identified by the system to require, for example, the user 1 to enter a password not only for user authentication prior to the transaction being carried out, but also as noted above to require the transaction verification application operation to be protected via a password or other protection as well.

The authentication unit 110 may be included in the server 104 and may be implemented by a programmable processor of server 104 executing suitable security code to perform authentication operations as known in the art and the operations described herein. As shown in block 200, a method includes initiating a transaction, such as a web transaction, by user 108 of the first unit 102 to authenticate the user to the desired website. This may be done using conventional authentication techniques requiring, for example, a user to submit a password and PIN prior to gaining access to a secure web page associated with a service provider. The transaction is initiated if the user authenticates properly with the server 104 using known techniques. The secure electronic transaction is then initiated via the web browser. In the example of a banking transaction a user may identify an account from which to transfer funds to another account and the dollar amount. As such, the method includes initiating an electronic transaction by a first unit 102 and server 104 using, for example, a first channel such as an internet connection or any other suitable channel via a web browser or other suitable interface by way of example.

As shown in block 202, during the electronic transaction, the second unit 106 receives a transaction confirmation request for the transaction and transaction information 136 from the server 104 via a back channel such as a mobile phone data network or wi-fi internet channel, based on the transaction.

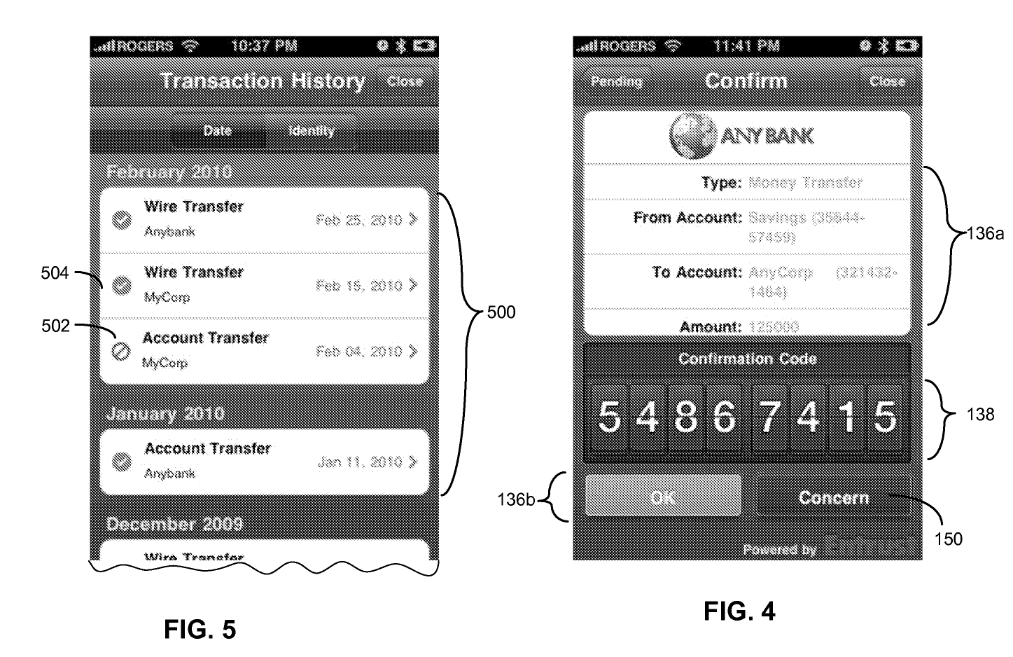

Referring also to FIG. 4, in the example where the user using the first unit 102 wishes to transfer money from their savings account to another entity and different account number in the amount of $125,000, this transaction information 136a is entered/selected by the user via the web browser and provided by the first unit to the server 104 so that the server can begin processing the transaction. The server 104 then sends the same transaction information 136a to the second unit 106 via a different channel along with a transaction confirmation request 136b (translated into an “OK” request GUI button) so that a user of the second device can confirm that the transaction should be carried out.

As such, as shown in block 204, the server sends the transaction information 136a and transaction confirmation request 136b to the second unit. This transaction information (TI) and confirmation requests (TCR) 136a and 136b respectively, are then provided through a user interface to a user of the second unit. In this example, since the second unit 106 is described as a wireless mobile device, a downloadable transaction verification application that provides a graphic user interface is shown in FIG. 4. The method includes during the electronic transaction, receiving from the server, by the second unit, the transaction confirmation request 136b and the transaction information 136a. The user interface provides the received transaction information 136a for evaluation by a user of the second unit. This may be done, for example, by the transaction verification application as shown in block 206. The transaction information 136a is provided via the user interface without the user having to enter the transaction information 136a into the device. It is automatically sent by the server and displayed in this example, without user intervention so the user need not enter the transaction information on the second device. Also the server—not the first unit—sends the transaction information to the second unit to avoid malware on the first unit from causing the display of incorrect transaction information. The second unit may then be used to confirm that the transaction should be accepted by, for example, activating the “OK” button which serves as confirmation of the transaction by the user of the second device. If malware on the first unit has, for example, changed the transaction information, the second unit will display the changed transaction information. Noticing that the second unit displays transaction information which does not accurately reflect the intended transaction terms, the user may for example activate a “Cancel” button to cancel the transaction (labeled in FIG. 4 as “Concern”), or alternatively may simply elect not to proceed with the transaction on unit 1 now that he is aware of the tampered transaction attempt.

As shown in block 208, the method includes generating by the second unit, a transaction confirmation code 138 that is based on the received transaction information 136a in response to a transaction confirmation by the user of the second unit. In this example, the transaction confirmation code 138 is cryptographically generated using an OATH algorithm using the seed key K that was provided to the second unit during the registration process. It will be recognized, however, that any suitable cryptographic digital signing technique that utilizes the transaction information 136a (e.g. all or portion thereof) to produce a transaction confirmation code may be employed. The method also includes sending the transaction confirmation code 138 back to the server 104 to confirm that the transaction should be completed. This may be done by the second unit when the user indicates that the transaction is confirmed, or by the first unit in the example where the code is displayed on the second unit and entered into the first unit or automatically sent to the first unit. In this latter case, the first unit then forwards the code to the server.

In one example, the user 108 may read the displayed transaction confirmation code 138 from the second device and enter it into the first unit which is shown by dashed line 140. In an alternative embodiment, the confirmation code 138 need not be shown but may instead be generated and sent as shown by arrow 142 (see FIG. 1) back to the server 104 for verification. Using this latter technique, the user need not reenter transaction confirmation codes and possibly improperly enter the code. Since the transaction confirmation code is signed, malware on the first unit is not a concern. Also sending the transaction verification code back to the server by the second unit removes the user from having to enter and potentially mistype information. These operations are shown, for example, in block 210.

As shown in block 212, in this example, the server 104 generates an expected transaction confirmation code using a corresponding seed using the same cryptographic algorithm used by the second unit so that if the transaction information is identical, the same transaction confirmation code generated by the second unit will also be generated by the server as the expected transaction confirmation code. The server 104 has access to the transaction information 136a because it received it from the first unit and had sent it to the second unit. The server having generated its own expected transaction code using, for example, the authentication unit 110, compares the expected transaction code to the received transaction confirmation code from the second unit (also referred to as destination unit). As shown in block 214, this is done to verify whether the transaction should be allowed. If the codes match, then the transaction is confirmed and the first unit is sent notification that the transaction is complete. In the example where the server and second unit employs an asymmetric public key approach, the server verifies the code using public key cryptographic signature verification techniques as known in the art so that a matching code is not generated.

As noted above, the second unit 106 generates the transaction confirmation code 138 by electronically signing the received transaction information using a cryptographic key associated with the second unit. This may be, for example, a seed key, private key, symmetric key or any other suitable key as desired. The seed information may also include information that identifies the second unit such as a serial number of the second unit that is provided to the server during the registration process.

As noted above with respect to block 206, the second unit may in one example, display the user interface that visually presents the received transaction information 136a in clear text and the user interface includes controls such as GUI buttons that are operative to confirm or cancel the transaction.

The method may also include sending a transaction cancellation message to the server from the second unit in response to a user cancellation of the transaction via a cancellation indication entered by the user. The user may select for the transaction to be cancelled using a cancellation button also labeled in FIG. 4 as concern button 150 which will cancel the transaction by the first unit although it is sent by the second unit.

As noted above, a generation of the transaction confirmation code k[TI] 138 by the second unit may be done by electronically signing the received transaction information 136a using, for example, a shared secret key such as an asymmetric encryption algorithm or OATH algorithm, or by using an asymmetric cryptographic algorithm such as a public and private key algorithm wherein a private signing key may be employed and the server can suitably verify the signature using public key verification techniques as known in the art.

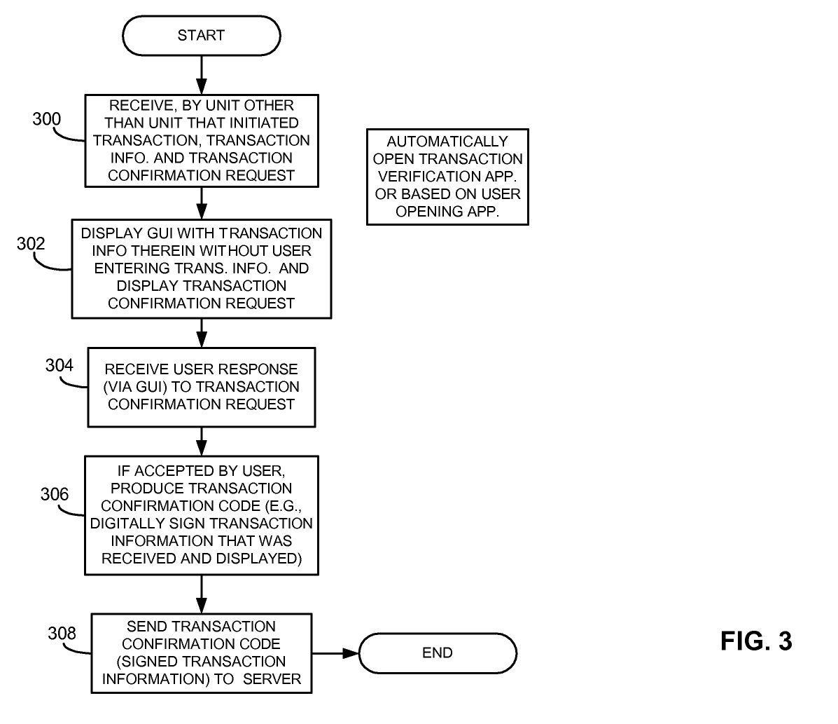

FIG. 3 illustrates a method of operation from the perspective of the second unit, in this example a wireless mobile device. As shown in block 300, the wireless mobile device receives the transaction information [TI] and transaction confirmation request [TCR] from the server as shown in block 302. The wireless mobile device displays a graphic user interface as shown, for example, in FIG. 4 that provides the transaction information 136a without the user entering the transaction information and displays a transaction confirmation request 136b (translated to a GUI button). The mobile device receives a user response via a GUI to the transaction confirmation request by, for example, the user hitting the OK button. The processor in the wireless device carries out an OATH algorithm operation as known in the art to produce the transaction confirmation code 138, or otherwise digitally sign the transaction information or portion thereof that was received from the server. This is shown in block 306. The transaction verification code may be generated automatically in response to receiving the transaction information and only sent when the transaction is approved via the second device or a the code can be generated when the transaction is confirmed. As shown in block 308, the mobile device can send the transaction confirmation code 138 (with or without displaying it) to the server 106 so that the server can then verify whether that transaction verification code generated by the second unit matches an expected transaction confirmation code generated by the server.

As shown in FIG. 5, since the wireless device may be utilized to verify multiple differing transactions with differing entities but for the same user, for example, a transaction history is maintained by the second unit in memory which may then be displayed via the graphic user interface as shown in FIG. 5. This transaction history data 500 corresponds to a plurality of electronic transactions that were confirmed or denied using the second unit. An indication 502 in this example that the transaction was not approved is shown and an indication, if desired, that a transaction was approved may also be shown as shown by data 504. Time stamps of the transactions are also recorded so that they may be used to designate dates and/or time of day, if desired, as to when a transaction has occurred. The time stamp information may be displayed on as part of the transaction history.

Among other advantages, the transaction information 136a is provided via the user interface without the user having to enter the transaction information 136a into the device. It is automatically sent by the server and displayed in this example, without user intervention so the user need not enter the transaction information on the second device. Also the server—not the first unit—sends the transaction information to the second unit to avoid malware on the first unit from causing display of false transaction information (data) on the second unit.

The above detailed description of the invention and the examples described therein have been presented for the purposes of illustration and description only and not by limitation. It is therefore contemplated that the present invention cover any and all modifications, variations or equivalents that fall within the spirit and scope of the basic underlying principles disclosed above and claimed herein.

What is claimed is:

1. A method for providing transaction verification comprising:
initiating an electronic transaction via by a first unit and a server in response to an initial user authentication;
during the electronic transaction, receiving from the server, by a second unit, a transaction confirmation request for the transaction and transaction information via a back channel based on the transaction;
providing through a user interface, by the second unit, the received transaction information for evaluation by a user of the second unit;
requesting by the second unit, in response to the transaction confirmation request, confirmation of the transaction by the user of the second unit;
generating, by the second unit, a transaction confirmation code based on the received transaction information in response to a transaction confirmation by the user of the second unit; and
sending the transaction confirmation code that is based on the received transaction information to the server for verification.

2. The method of claim 1 comprising generating an expected transaction confirmation code for the second unit and comparing the expected transaction confirmation code with the received transaction confirmation code from the second unit to verify whether the transaction should be allowed.

3. The method of claim 1 wherein the second unit generates the transaction confirmation code by electronically signing the received transaction information using a cryptographic key associated with the second unit.

4. The method of claim 1 comprising displaying on the second unit a user interface that visually presents the received transaction information in clear text and wherein the user interface comprises controls operable to confirm or cancel the transaction.

5. The method of claim 1 comprising sending a transaction cancellation message to the server from the second unit in response to user cancellation of the transaction via a cancellation indication entered by the user of the second unit in response to presentation of the received transaction information from the server.

6. The method of claim 3 wherein the second unit generates the transaction confirmation code by electronically signing the received transaction information using at least one of: a shared secret key assigned to the second unit and to the server, or by using an asymmetric cryptographic algorithm.

7. An electronic transaction system comprising:
a server operative to provide a transaction session and communicate via a back channel with a second unit;
a first unit operative to initiate an electronic transaction with the server in response to user authentication affirmation;
the second unit operative to;
receive during the transaction, a transaction confirmation request for the electronic transaction and transaction information based on the electronic transaction from the server
provide through a user interface without user intervention, the received transaction information for evaluation by a user of the second unit
request, in response to the transaction confirmation request, confirmation of the transaction by the user;
generate a transaction confirmation code based on the received transaction information in response to a transaction confirmation by the user; and
send the transaction confirmation code that is based on the received transaction information to the server for verification.

8. The system of claim 7 wherein the server is operative to cryptographically generate an expected transaction confirmation code for the second unit and compare the expected transaction confirmation code with the received transaction confirmation code from the second unit to verify whether the transaction should be allowed.

9. The system of claim 7 wherein the second unit generates the transaction confirmation code by electronically signing the received transaction information using a cryptographic key associated with the device.

10. The system of claim 7 wherein the second unit is a wireless mobile unit and is operative to provide an user interface that visually presents the received transaction information in clear text on the user interface and wherein the user interface comprises user controls operable to confirm or cancel the transaction.

11. The system of claim 10 wherein the second unit is operative to send a transaction cancellation message to the server in response to user cancellation of the transaction via a cancellation indication entered by the user of the second unit in response to presentation of the received transaction information from the server.

12. The system of claim 9 wherein the second unit generates the transaction confirmation code by electronically signing the received transaction information using at least one of: a shared secret key assigned to the second unit and to the server, or by using an asymmetric cryptographic algorithm.

13. The system of claim 7 wherein the second unit is operative to store and display on a user interface, transaction history data corresponding to a plurality of electronic transactions that were confirmed or cancelled using the second unit.

14. A wireless mobile device comprising:
a wireless transceiver;
one or more processors operatively coupled to the wireless transceiver;
memory comprising executable instructions that when executed cause the one or more processors to:
receive from the transceiver during the transaction, a transaction confirmation request for the electronic transaction and transaction information based on the electronic transaction from the web server
provide through a user interface, the received transaction information for evaluation by a user of the mobile device
request, in response to the transaction confirmation request, confirmation of the transaction by the user of the mobile device;
generate a transaction confirmation code based on the received transaction information in response to a transaction confirmation by the user of the mobile device; and
send, via the wireless transceiver, the transaction confirmation code that is based on the received transaction information to the web server for verification.

15. The wireless mobile device of claim 14 wherein the one or more processors are operative to generate the transaction confirmation code by electronically signing the received transaction information using a cryptographic key associated with the device.

16. The wireless mobile device of claim 14 wherein the one or more processors are operative to display a user interface that visually presents the received transaction information in clear text and wherein the user interface comprises controls operable to confirm or cancel the transaction.

17. The wireless mobile device of claim 14 wherein the one or more processors are operative to send a transaction cancellation message to a server in response to user cancellation of the transaction via a cancellation indication entered by the user of the device in response to presentation of the received transaction information from the server.

18. The wireless mobile device of claim 15 wherein the one or more processors are operative to generate the transaction confirmation code by electronically signing the received transaction information using at least one of: a shared secret key assigned to the mobile device and to a server, or by using an asymmetric cryptographic algorithm.

19. The wireless mobile device of claim 14 wherein the one or more processors are operative to store and display on a user interface, transaction history data corresponding to a plurality of electronic transactions that were confirmed or cancelled using the mobile device.
